(19) United States
(12) Patent Application Publication
(10) Pub. No.: US 2025/0102102 A1
(43) Pub. Date: Mar. 27, 2025

(54) Passive Cooling of Liquid Gases in a System

(71) Applicant: KSB SE & Co. KGaA, Frankenthal (DE)

(72) Inventor: Marco KROTH, Frankenthal (DE)

(21) Appl. No.: 18/730,385

(22) PCT Filed: Jan. 4, 2023
(86) PCT No.: PCT/EP2023/050106

§ 371 Date: Jul. 19, 2024

(30) Foreign Application Priority Data
Jan. 21, 2022 (DE) 10 2022 101 402.9

(51) Int. Cl. F16L 59/14

(52) U.S. Cl. CPC F16L 59/141

(57) ABSTRACT

A system includes having an inner wall and an outer wall. The inner wall encloses a liquid gas in a first chamber. A second chamber is formed between the inner wall and the outer wall. The inner wall has at least one opening configured to expand the liquid gas into the second chamber.

### CROSS REFERENCE TO RELATED APPLICATION

This application claims priority under 35 U.S.C. § 119 from German Patent Application No. 102022101402.9, filed Jan. 21, 2022, the entire disclosure of which is herein expressly incorporated by reference.

### BACKGROUND

The disclosure relates to a system comprising an arrangement having an inner wall and an outer wall, wherein the inner wall encloses a liquid gas in a first chamber, and a second chamber is formed between the inner wall and the outer wall.

The system can be embodied as a pipeline or fitting, for example. Pipelines consist of pipes, pipe connections and the associated fittings. They are used to transport fluids and free-flowing or pumpable solids and to transmit mechanical and thermal energy.

A fitting denotes a component for varying, or for exercising open-loop and/or closed-loop control over, substance flows, which is used, in particular, with pipelines and containers for gases and liquids.

Moreover, a system may also be embodied as a container. A container or vessel is an object which has an internal cavity and serves the purpose, in particular, of separating its contents from its surroundings. A wall that surrounds the cavity as a sheet-like structure is generally used for this purpose.

Liquid gas or liquefied gas denotes gases that have been liquefied by cooling and/or compression and remain cold and liquid either at normal pressure on account of the heat of vaporization and/or with appropriate thermal insulation, or are pressurized in order to maintain the liquefied state.

Moreover, liquid gases can be stored and transported in adequately insulated systems. It may be possible to keep the temperature of the liquefied gas in a system constant by passive cooling, in particular by slow and continuous boiling of a small proportion of the liquid gas.

DE 21 03 581 C2 discloses a pipeline for transporting liquids at low temperature, comprising an inner pipe, to which an axial load can be applied, and a coaxial outer pipe, which are supported on one another by connecting pieces and between which a thermal insulation layer is provided.

U.S. Pat. No. 7,578,315 B2 describes a compound pipe assembly comprising an inner non-pressure bearing pipe, which is arranged within an outer pressure bearing pipe. A first insulating material insulates the inner pipe from the outer pipe, wherein the insulating material and the outer pipe form a fluid channel, into which a stream of fluid flows from the inner pipe via through-holes or vents.

It is the object of the disclosure to specify a system comprising an arrangement that can adequately cool liquid gases in a passive way. For this purpose, the system is to be designed in such a way that no energy has to be expended for cooling. Moreover, the system is to be of particularly simple design and to be capable of being implemented at low cost.

According to the disclosure, this object is achieved by a system comprising an arrangement. Preferred variants can be found in the additional independent claims, the dependent claims, the description and the drawings.

According to the disclosure, the inner wall can have at least one opening for the expansion of the liquid gas into the second chamber.

The system is preferably used to provide gases that are liquefied for transportation and/or storage. To this extent, the system should preferably be understood as the last leg of transportation between storage or transportation and use, which then takes place in the gas phase, however.

For this purpose, the arrangement has a first chamber as an inner transport pipe, which is closed off by the inner wall, wherein the inner wall is surrounded by an outer wall. The outer wall, in turn, is preferably of insulated design, wherein the insulation meets the requirements of extreme low temperatures.

Ideally, the arrangement has more than two, preferably more than three, in particular more than four, openings, through which the liquefied gas expands into the second chamber, which is formed between the inner and outer walls. During this process, the liquefied gas vaporizes and removes the heat of vaporization from the system. As a result, the system, in particular the liquefied gas within the inner wall, is cooled to such an extent that no external cooling of the system is necessary to keep the liquefied gas in the liquid state.

In this arrangement, the openings are distributed in the system in such a way that heat is removed in a manner that is uniform over the entire system.

In an advantageous variant of the disclosure, the inner wall is arranged with at least one spacing element within the outer wall. The larger the arrangement, the more spacing elements are arranged between the inner and outer walls. As a result, a second chamber, into which the vaporized liquefied gas can flow, is advantageously formed in a uniformly spaced manner between the inner and outer walls. The uniform spacing and the circumferential enclosure of the inner wall by the outer wall, in combination with uniformly distributed openings through which the liquefied gas vaporizes into the second chamber, promote outstanding passive cooling of the inner wall. The liquefied gas is thereby held in the liquid state.

Ideally, the arrangement has at least one connection piece. The connection piece is preferably arranged on the outer wall. After the removal of the heat of vaporization, this enables the vaporized liquefied gas to be supplied for further use.

In an alternative variant, the gas flowing out via the connection piece can also be fed to a temporary storage system.

Evaporative cooling by means of liquefied gases in continuous-flow systems is advantageously outstandingly suitable for passive cooling of the system. Particularly in systems which are designed as fittings and/or shaped pieces of pipeline that may not be adequately insulated, passive cooling is advantageously combined with the provision of the previously liquid gas in the gaseous state for further use.

Ideally, the system has at least one sensor. In this case, the sensor can be arranged within the inner wall, and/or on the inner wall, and/or in the second chamber between the inner and outer wall, and/or on the outer wall, and/or on an opening, and/or on a connection piece, and/or on a spacing element.

The advantageous implementation of at least one sensor provides monitoring of the system. It is thereby possible to continuously monitor and, if appropriate, automatically influence the state of the system.

In a particularly advantageous variant of the disclosure, the sensor is embodied as a temperature sensor, e.g. as a resistance thermometer. The temperature sensor preferably records the temperature of the liquid gas.

In an advantageous variant of the disclosure, the sensor is designed as a pressure sensor. Ideally, the pressure sensor can detect the pressure between the inner and outer walls.

In another variant of the disclosure, the sensor is embodied as a flow sensor. In this case, the flow from the inner wall into the chamber between the inner and outer walls and/or the flow at the connection piece can be measured, for example.

In an alternative variant of the disclosure, the system comprises at least one element for varying an opening cross section. The element can serve, for example, as a flap for the closed-loop and/or open-loop control of the expansion of the liquid gas. Alternatively, it is also possible for the flap to influence the inflow of the liquid gas within the inner wall. Furthermore, such an element can interrupt the inflow of the liquid gas if the system temperature is too high.

The system can preferably also comprise an element for varying the cross section of the connection piece. It is thereby preferably possible for the gas inflow for further use to be subjected to open-loop and/or closed-loop control.

In a particularly advantageous variant of the disclosure, the inner wall is formed from a particularly thermally conductive material. This can be copper or a copper alloy or aluminum or an aluminum alloy, for example.

The outer wall and/or the connection piece and/or the spacing elements are preferably formed from a material which has particularly poor thermal conductivity. This may be, for example, a plastic resistant to low temperatures, such as PE-UHMW or PTFE. However, steels that are resistant to low temperatures, such as austenitic stainless steels, titanium alloys or maraging steels, may also be used.

In an advantageous variant of the disclosure, one wall and/or all the walls of the arrangement can have a coating which influences the heat transfer and the heat transmission to perform the task of the system.

In a particularly advantageous variant of the disclosure, the inner wall of the outer wall has a coating which additionally reduces the heat transmission through the outer pipe.

Ideally, the system is surrounded by insulation which is suitable for use at low temperatures. In particular, the outer wall is provided with insulation, e.g. a synthetic resin compressed wood impregnated with special resins.

In an alternative variant of the disclosure, the inner wall has cooling fins, as a result of which the heat of vaporization can be removed more effectively from the inner pipe wall.

Preferred examples of liquefied gases in the system are liquid propane, liquid methane, liquid oxygen, liquid nitrogen, liquid hydrogen and liquid helium.

In a particularly preferred variant of the disclosure, the system with an arrangement is produced generatively. It is thereby possible to achieve complex geometries of the arrangement and/or specific shapes of the openings.

According to the disclosure, in a method for producing a system comprising an arrangement for passive cooling of liquid gases, the arrangement is produced by the selective action of radiation on a construction material.

The designation “generatively or additively produced” comprises all manufacturing methods in which material is applied layer by layer and in this way three-dimensional components are produced. Here, the buildup in layers takes place under computer control from one or more liquid or solid materials according to specified dimensions and shapes. During the buildup, physical or chemical curing or melting processes take place. Typical materials for “3D printing” are plastics, metals, carbon materials and graphite materials.

A particularly advantageous form of additive design is selective laser melting. In selective laser melting, the metallic buildup material is applied in powder form in a thin layer to a plate. The powdered material is completely melted locally at the respectively desired locations and, after solidifying, forms a solid material layer. This base plate is then lowered by the amount of a layer thickness and powder is applied again. This cycle is repeated until all the layers have been melted. Excess powder is cleaned off the finished parts of the arrangement. In order to achieve the desired properties of the respective part of the arrangement, the respectively appropriate material in powder form can be used.

As radiation, it is possible, for example, to use a laser beam, which generates the parts of the arrangement from the individual powder layers. The data for guiding the laser beam are produced by means of software on the basis of a 3D CAD body. Alternatively to selective laser melting, it is also possible to use an electron beam (EBM).

In an alternative variant of the disclosure, the system is produced in a conventional manner. The designation “produced in a conventional manner” denotes an arrangement which is produced and possibly assembled by means of primary forming, forming or a subtractive manufacturing method.

According to the disclosure, there is a flow of liquid gases through the system with an arrangement, during which process cooling is carried out passively by the system itself and used to provide the gas in gaseous form.

Further features and advantages of the disclosure can be derived from the description of exemplary embodiments with reference to the drawings and from the drawings themselves.

### BRIEF DESCRIPTION OF THE DRAWINGS

In the drawings:

FIG. 1 shows a longitudinal section through an exemplary system;

FIG. 2 shows an illustration of a cross section through an exemplary system;

FIG. 3 shows a longitudinal section from another perspective; and

FIG. 4 shows a perspective illustration of the system.

### DETAILED DESCRIPTION

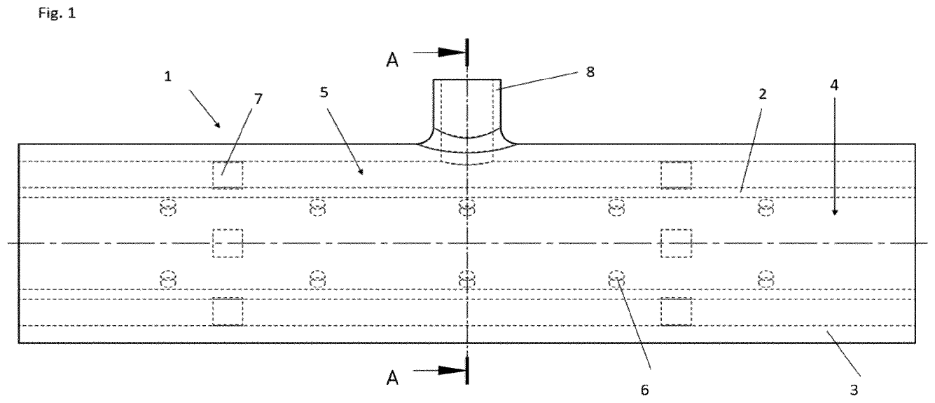

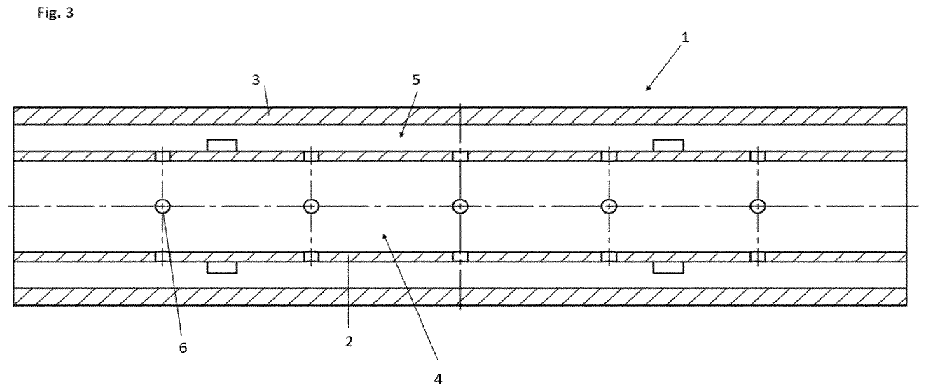

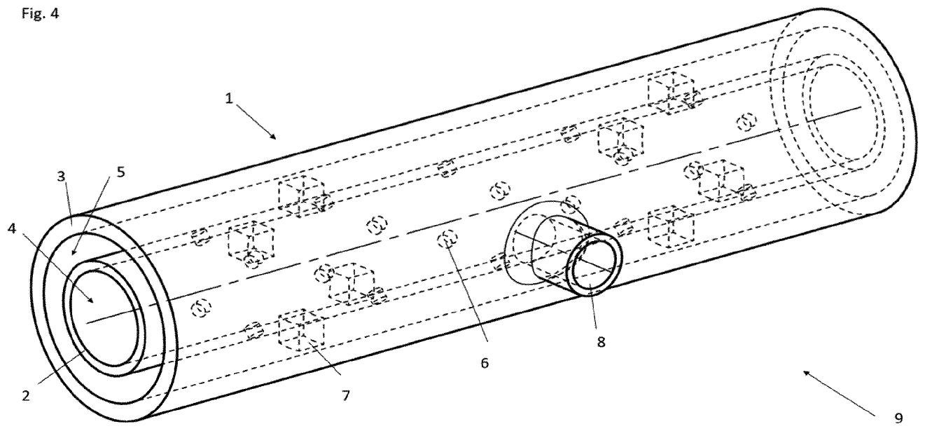

FIGS. 1 to 4 show various illustrations of an exemplary system 9, which has an arrangement 1 with an inner wall 2 and an outer wall 3. In the variant embodiments illustrated, the system 9 is shown as a piece of a pipeline having a connection piece 8 for the removal of the gas for further use.

The inner wall 2 surrounds a first chamber 4, in which the liquid gas is transported. In the inner wall 2, the illustrated system 9 has twenty openings 6, through which the liquid gas expands into the second chamber 5. During this process, the liquid gas vaporizes and removes the heat of vaporization from the system 9, in particular from the liquid gas in the first chamber 4, as a result of which the system 9 undergoes enormous passive cooling.

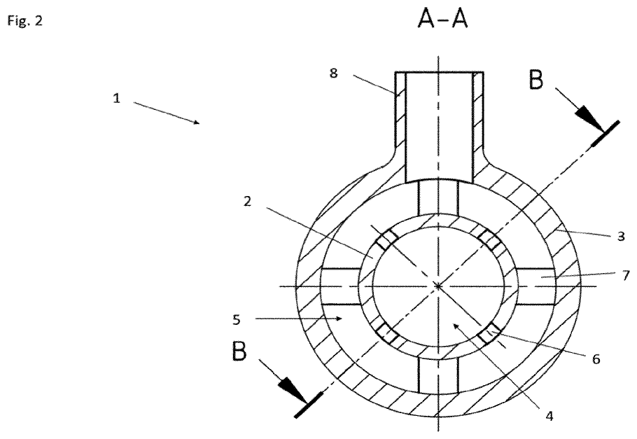

Every four openings 6 form an imaginary ring, in which one opening 6 is arranged offset by 90° from the next opening 6, as is particularly clear in the section A-A in FIG. 2.

A further imaginary ring of four spacing elements 7 is arranged between two such rings of openings 6. Each spacing element 7 is positioned so as to be offset by 90° from the next spacing element 7, wherein the openings 6 are each arranged offset by 45° with respect to the spacing elements 7.

The spacing elements 7 space the inner wall 2 apart from the outer wall 3, wherein the second chamber 5 is formed between the inner wall 2 and the outer wall 3. In this second chamber 5, the vaporized gas flows in the direction of the connection piece 8, which feeds the gas to its further use.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-11. (canceled)

12. A system comprising:
an arrangement having an inner wall and an outer wall, wherein
the inner wall encloses a liquid gas in a first chamber,
a second chamber is formed between the inner wall and the outer wall, and
the inner wall has at least one opening configured to expand the liquid gas into
the second chamber.

13. The system as claimed in claim 12, wherein the inner wall is arranged with at least one spacing element within the outer wall.

14. The system as claimed in claim 13, wherein the arrangement has at least one connection piece.

15. The system as claimed in claim 14, wherein the arrangement has more than two openings.

16. The system as claimed in claim 15, wherein the system has at least one sensor.

17. The system as claimed in claim 16, wherein the system comprises at least one element configured to change the opening cross section.

18. The system as claimed in claim 17, wherein the arrangement is produced generatively.

19. The system as claimed in claim 17, wherein the arrangement is produced in a conventional manner.

20. The system as claimed in claim 19, wherein the outer wall has a coating.

21. A method for producing a system comprising:
an arrangement for passive cooling of liquid gases, wherein the arrangement is produced by the selective action of radiation on a construction material.

22. The method as claimed in claim 21, further comprising: using the system to flow therethrough liquid gases, in order to provide the gases in gaseous form.
